(19) United States
(12) Patent Application Publication
(10) Pub. No.: US 2011/0070426 A1
(43) Pub. Date: Mar. 24, 2011

(54) SINTERING AIDS FOR BORON CARBIDE ULTRAFINE PARTICLES

(76) Inventors: Noel R. Vanier, Wexford, PA (US); Cheng-Hung Hung, Wexford, PA (US)

(21) Appl. No.: 12/938,395

(22) Filed: Nov. 3, 2010

Related U.S. Application Data
(63) Continuation-in-part of application No. 11/873,712, filed on Oct. 17, 2007.
Application No. 11/873,712 is a continuation-in-part of application No. 11/468,424, filed on Aug. 30, 2006, now Pat. No. 7,635,458.

(51) Int. Cl. C04B 35/563; C04B 35/622; B32B 18/00; B32B 5/16

(52) U.S. Cl. 428/325; 501/87; 428/402

(57) ABSTRACT

Ultrafine boron carbide particles with selected sintering aids are disclosed. The sintering aids may be provided inside the ultrafine boron carbide particles or on the surfaces thereof. When the ultrafine boron carbide particles and sintering aids are sintered, the resultant materials possess relatively high densities and relatively small boron carbide grain sizes.

### CROSS REFERENCE TO RELATED APPLICATIONS

This application is a continuation-in-part of U.S. patent application Ser. No. 11/873,712 filed Oct. 17, 2007, which is a continuation-in-part of U.S. patent application Ser. No. 11/468,424 filed Aug. 30, 2006, both of which are incorporated herein by reference.

### GOVERNMENT CONTRACT

This invention was made with United States government support under Contract Number W911NF-05-9-0001 awarded by DARPA. The United States government has certain rights in this invention.

### FIELD OF THE INVENTION

The present invention relates to sintered ultrafine boron carbide particles, and more particularly relates to the addition of selected sintering aids to such ultrafine boron carbide particles to improve the properties of the sintered materials.

### BACKGROUND OF THE INVENTION

Boron carbide particles having particle sizes of greater than 0.2 micron have been produced by solid phase synthesis using B₂O₃ and carbon as starting reactant materials and subsequent milling. Such particles may be sintered to form various products such as armor panels and abrasion resistant nozzles. Sintering aids may be added to such boron carbide particles by milling in order to obtain a mixture that is homogeneous on a macro scale. However, these mixtures are not uniform on a micro scale, and such non-uniformities may adversely affect sintering of the particles and cause defects in the sintered bodies that degrade mechanical properties. Furthermore, sintered materials made from such milled boron carbide particles have relatively large grain sizes and do not exhibit optimal mechanical properties.

### SUMMARY OF THE INVENTION

An aspect of the invention provides sintered ultrafine boron carbide particles comprising from 0.05 to 15 weight percent of a sintering aid comprising at least two metals selected from Ti, Al, W, Mg, Zr and Mo.

Another aspect of the invention provides ultrafine boron carbide particles having an average particle size of less than 100 nm comprising from 0.05 to 15 weight percent of a sintering aid comprising at least two metals selected from Ti, Al, W, Mg, Zr and Mo.

A further aspect of the invention provides a method of making ultrafine boron carbide particles with sintering aids comprising forming at least two sintering aid metals selected from Ti, Al, W, Mg, Zr and Mo on or in ultrafine boron carbide particles.

### BRIEF DESCRIPTION OF THE DRAWINGS

FIG. 1 is a flowchart depicting the steps of certain methods of the present invention.

FIG. 2 is a partially schematic sectional view of an apparatus for producing ultrafine boron carbide particles with sintering aids including a feed line for a mixture of boron-containing precursor, carbon-containing precursor and sintering aid materials in accordance with certain embodiments of the present invention.

FIG. 3 is a partially schematic sectional view of an apparatus for producing ultrafine boron carbide particles with sintering aids including a feed line for a mixture of boron-containing precursor, carbon-containing precursor and sintering aid materials in accordance with certain embodiments of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

Certain embodiments of the present invention are directed to methods for making ultrafine boron carbide particles including sintering aids, as well as the ultrafine boron carbide particles and sintered products produced by such methods. Examples of ultrafine boron carbides that may be produced include B₄C, B₁₃C₂, B₈C, B₁₀C and B₂₅C.

As used herein, the term “ultrafine boron carbide particles” refers to boron carbide particles having a B.E.T. specific surface area of at least 5 square meters per gram, such as 20 to 200 square meters per gram, or, in some cases, 30 to 100 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the ultrafine boron carbide particles made in accordance with the present invention have a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:

Diameter(nanometers)=6000/[BET(m²/g)*ρ(grams/cm³)]

In certain embodiments, the ultrafine boron carbide particles have an average particle size of no more than 100 nanometers, in some cases, no more than 50 nanometers or, in yet other cases, no more than 30 or 40 nanometers. As used herein, the term “average particle size” refers to a particle size as determined by visually examining a micrograph of a transmission electron microscopy (“TEM”) image, measuring the diameter of the particles in the image, and calculating the average particle size of the measured particles based on magnification of the TEM image. One of ordinary skill in the art will understand how to prepare such a TEM image and determine the average particle size based on the magnification. The size of a particle refers to the smallest diameter sphere that will completely enclose the individual particle.

In accordance with certain embodiments of the invention, the ultrafine boron carbide particles include sintering aids. Sintering aids that may be incorporated in the ultrafine boron carbide particles include Ti, Al, W, Mg, Zr, Mo and combinations thereof. In certain embodiments, the sintering aids comprise at least two of these metals, e.g., Ti and/or Al in combination with W and/or Mg. Additional metals may also be included, such as Fe, Na, Ca, Si, Y, La, Hf, Ta, Ni, Co, V, Nb, Ce, Mn, Li and Nd. The sintering aids may be uniformly distributed on a submicron or nano scale, which provides uniform dispersion when the ultrafine boron carbide particles are subsequently sintered. The sintering aids are typically present in an amount up to about 15 weight percent, for example, from about 0.01 or 0.05 to about 3 or 5 weight percent.

In accordance with certain embodiments of the invention, the sintering aids are provided as precursor materials, along with boron carbide precursors, as the starting materials for the production of the ultrafine boron carbide particles. Thus, the sintering aids may be present during the formation of the ultrafine boron carbide particles. For example, a plasma system as more fully described below, may be used to simultaneously form the boron carbide particles with the sintering aids in or on the surface of the boron carbide particles. The sintering aid precursor materials may be provided as metals or metal alloys, or may be provided as oxides, hydroxides, borides, carbides, etc. of the sintering aid metals. For example, Ti, Al, W and Mg sintering aids may be provided in the form of oxides of such metals, e.g., TiO₂, Al₂O₃, WO₃ and MgO. Alternatively, in certain embodiments, the sintering aids may be added to the ultrafine boron carbide particles after they are formed.

In one embodiment, as the ultrafine boron carbide particles are formed, the sintering aid is incorporated within each of the ultrafine boron carbide particles and/or on the surface of each ultrafine boron carbide particle. The sintering aid is therefore uniformly distributed on a submicron or nano scale, which provides uniform dispersion of the sintering aid when the ultrafine particles are subsequently sintered. As used herein, the term “substantially uniformly distributed in the ultrafine boron carbide particles”, when referring to the sintering aid material, means that the sintering aid is incorporated within the ultrafine boron carbide particles and/or on the surfaces of the ultrafine boron carbide particles such that the sintering aid is evenly distributed with the powder on a submicron scale. Standard transmission electron microscopy (TEM) techniques may be used to determine such uniform sintering aid distributions. When such ultrafine boron carbide particles are subsequently sintered, the resultant products comprise ultrafine sintering aid materials uniformly distributed throughout the consolidated body. Such sintering aid materials are typically smaller than the ultrafine boron carbide particles, e.g., less than 100 nm in size, for example, less than 50 nm or 40 nm.

In another embodiment, the sintering aids are combined with the ultrafine boron carbide particles after they are formed. For example, sintering aid particles may be deposited on the surfaces of pre-formed boron carbide particles by precipitating the sintering aid metals from solutions containing alkoxides of the metals. For example, raw boron carbide powder may be dispersed in de-ionized water, and the boron oxide impurities on the surfaces of the boron carbide particles may be removed by adding an acid solution (e.g., sulfuric acid, hydrochloric acid, hydrofluoric acid, citric acid, etc.) to aid in the dissolution process. The particles may be recovered using a filtration process. Additional de-ionized water may be used to rinse and remove any impurity residue. The filter cake may be dispersed in isopropanol to form a uniform dispersion. Some metal alkoxides may be added to the solution with agitation. Then de-ionized water may be used to hydrolyze the alkoxides and precipitate them from the solution. The boron carbide particles with the sintering aids deposited may then be collected using a filtration process. Alternatively, water soluble salts of the sintering aid metals that will thermally decompose to metal oxides at low temperatures (e.g., less than 600° C.) may be added to the uniform purified dispersion. Suitable salts include, for example, lactates. Ammonium tungsten oxide may be used in the case of tungsten. The dispersion solution may then be dried by any suitable technique such as spray drying. Subsequent heating in the preheating and/or sintering process will generate the oxide sintering aid particles ultimately dispersed on the boron carbide particles.

Materials sintered from the ultrafine boron carbide particles of the present invention have been found to possess high densities and relatively small grain sizes. In certain embodiments, the as-sintered density is greater than 92 percent, for example, greater than 94 or 95 percent of theoretical density or higher after pressureless sintering. In certain embodiments, densities of greater than 96 or 97 percent may be achieved, for example, greater than 98 or 99 percent after pressure sintering.

The average grain size of the sintered boron carbide materials is typically less than 10 microns, for example, less than 5 microns. In certain embodiments, the average grain size is less than 1 or 2 microns. The term “average grain size” is used herein in accordance with its standard meaning in the art and can be determined in accordance with the ASTM E112 standard. The sintered boron carbide materials may also be substantially devoid of non-uniformities and defects that normally would result from doping, thus resulting in significantly improved mechanical properties.

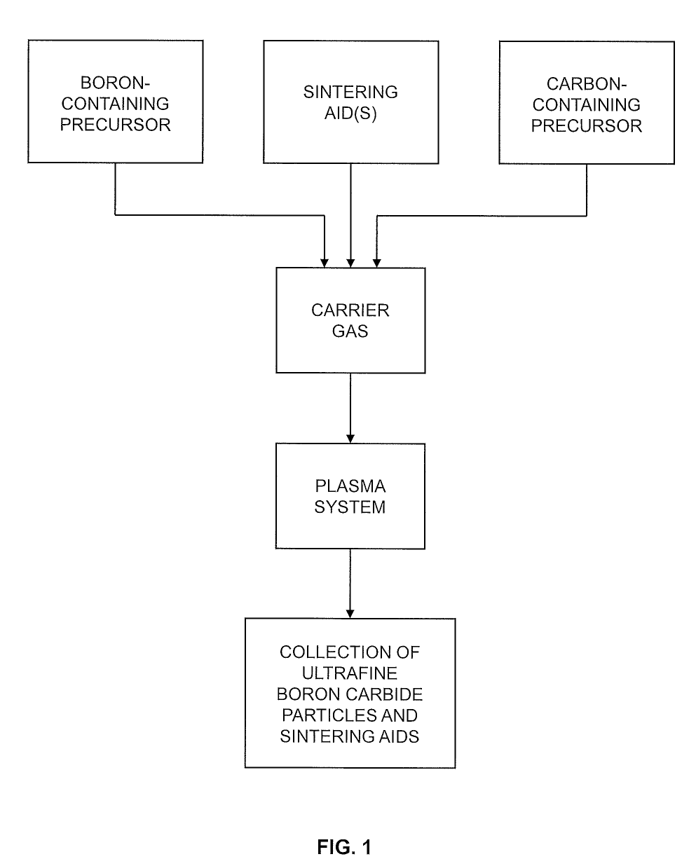

FIG. 1 is a flow diagram depicting certain embodiments of the methods of the present invention. A boron-containing precursor, carbon-containing precursor and sintering aid are provided as feed materials. In the embodiment shown in FIG. 1, the precursors and sintering aid are provided from three separate sources. However, the feed materials may be provided from a single source or from multiple sources.

In one embodiment, the boron-containing and/or carbon-containing precursors may be provided in liquid form. The term “liquid precursor” means a precursor material that is liquid at room temperature. In accordance with certain embodiments in which boron carbide powders are produced, suitable liquid boron-containing precursors include borate esters and other compounds containing boron-oxygen bonds. For example, the liquid boron-containing precursor may comprise trimethylboroxine, trimethylborate and/or triethylborate. The carbon-containing precursor may be in liquid form and may comprise aliphatic carbon atoms and/or aromatic carbon atoms. For example, the liquid carbon-containing precursor may comprise acetone, iso-octane and/or toluene. In certain embodiments, the liquid carbon-containing precursor may comprise an organic liquid with a relatively high C:H atomic ratio, e.g., greater than 1:3 or greater than 1:2. Furthermore, such liquid hydrocarbon precursors may also have a relatively high C:O atomic ratio, e.g., greater than 2:1 or greater than 3:1.

In certain embodiments, a single liquid may be provided as the feed material. For example, boron-containing compounds such as B₂O₃ or borax particles may be suspended or dissolved in an organic liquid such as methanol, glycerol, ethylene glycol or dimethyl carbonate. Thus, the liquid boron-containing precursor and liquid carbon-containing precursor may comprise hydrocarbon solvents in which particulate boron-containing precursors are at least partially suspended or dissolved. As another example, polypropylene powder may be suspended in trimethylborate liquid.

In accordance with certain embodiments, the ratio of boron-containing precursor to carbon-containing precursor is controlled in order to control the composition of the resultant boron carbide and/or in order to control the formation of excess boron or excess carbon in the ultrafine boron carbide particles. For example, if an excess amount of boron-containing precursor is used, excess boron may form on or in the ultrafine boron carbide particles, which may react with oxygen or air to form oxide compounds. As a further example, an excess amount of carbon-containing precursor in the starting feed material may cause the formation of graphite on or in the resultant boron carbide particles.

In certain embodiments, the boron-containing, carbon-containing and/or sintering aid precursors may be provided in solid particulate form. For example, ultrafine boron carbide particles may be produced from B₂O₃ as the boron source, carbon black or a polymer such as polypropylene as the carbon source, and at least one metal, metal oxide, metal carbonate, metal salt, solid organometallic or metal hydroxide as the sintering aid source. Alternatively, the carbon source may be a liquid as described above, or a gas such as methane or natural gas.

As shown in FIG. 1, in accordance with certain methods of the present invention, the boron-containing precursor, carbon-containing precursor and sintering aid are contacted with a carrier. The carrier may be a gas that acts to suspend or atomize the precursors in the gas, thereby producing a gas-stream in which the precursors are entrained. Suitable carrier gases include, but are not limited to, argon, helium, hydrogen, or a combination thereof.

Next, in accordance with certain embodiments of the present invention, the precursors and sintering aids are heated by a plasma system, e.g., as the entrained precursors flow into a plasma chamber, yielding a gaseous stream of the precursors and/or their vaporized or thermal decomposition products and/or their reaction products. In certain embodiments, the precursors are heated to a temperature ranging from 1,500° to 20,000° C., such as 1,700° to 8,000° C.

In certain methods of the present invention, after the gaseous stream is produced, it is contacted with one or more quench streams that are injected into the plasma chamber through at least one quench stream injection port. For example, the quench streams are injected at flow rates and injection angles that result in impingement of the quench streams with each other within the gaseous stream. The material used in the quench streams is not limited, so long as it adequately cools the gaseous stream to facilitate the formation or control the particle size of the boron carbide particles. Materials suitable for use in the quench streams include, but are not limited to, inert gases such as argon, helium, nitrogen, hydrogen gas, ammonia, mono, di and polybasic alcohols, hydrocarbons, amines and/or carboxylic acids.

In certain embodiments, the particular flow rates and injection angles of the various quench streams may vary, so long as they impinge with each other within the gaseous stream to result in the rapid cooling of the gaseous stream. For example, the quench streams may primarily cool the gaseous stream through dilution, rather than adiabatic expansion, thereby causing a rapid quenching of the gaseous stream, before, during and/or after the formation of the ultrafine boron carbide particles prior to passing the particles into and through a converging member, such as a converging-diverging nozzle, as described below.

In certain embodiments of the invention, after contacting the gaseous product stream with the quench streams to cause production of boron carbide particles, the ultrafine particles may be passed through a converging member, wherein the plasma system is designed to minimize the fouling thereof. In certain embodiments, the converging member also comprises a diverging section, e.g., a converging-diverging (De Laval) nozzle. In these embodiments, while the converging-diverging nozzle may act to cool the product stream to some degree, the quench streams perform much of the cooling so that a substantial amount of the ultrafine boron carbide particles are formed upstream of the nozzle. In these embodiments, the converging-diverging nozzle may primarily act as a choke position that permits operation of the reactor at higher pressures, thereby increasing the residence time of the materials therein. The combination of quench stream dilution cooling with a converging-diverging nozzle appears to provide a commercially viable method of producing ultrafine particles using a plasma system, since, for example, in certain embodiments the feed materials can be used effectively without the necessity of heating the feed materials to a gaseous state before injection into the plasma. Alternatively, liquid feed materials may be vaporized prior to introduction to the plasma system.

As is seen in FIG. 1, in certain embodiments of the methods of the present invention, after the ultrafine boron carbide particles exit the plasma system, they are collected. Any suitable means may be used to separate the ultrafine particles from the gas flow, such as, for example, a bag filter, cyclone separator or deposition on a substrate.

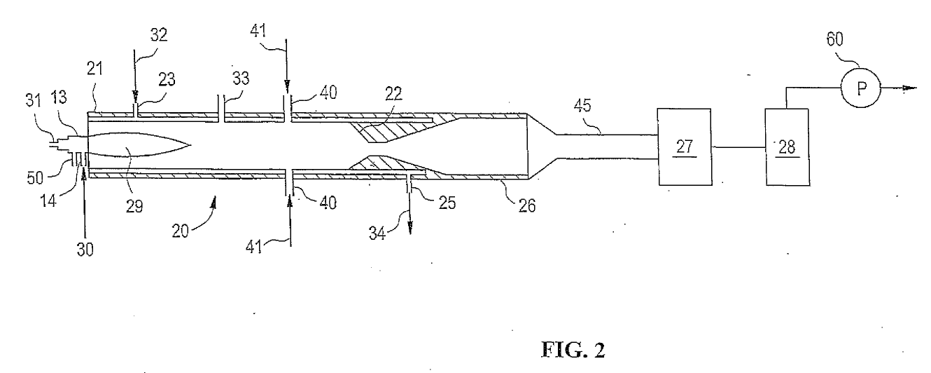

FIG. 2 is a partially schematic sectional diagram of an apparatus for producing ultrafine boron carbide particles in accordance with certain embodiments of the present invention. A plasma chamber 20 is provided that includes a feed inlet 50 which, in the embodiment shown in FIG. 2, is used to introduce a mixture of the boron-containing precursor, carbon-containing precursor and sintering aid into the plasma chamber 20. In another embodiment, the feed inlet 50 may be replaced with one or more separate inlets (not shown) for the boron-containing precursor, carbon-containing precursor and/or sintering aid(s). Also provided is at least one carrier gas feed inlet 14, through which a carrier gas flows in the direction of arrow 30 into the plasma chamber 20. The carrier gas may act to suspend or atomize the precursors in the gas, thereby producing a gas-stream with the entrained precursors which flows towards plasma 29. Numerals 23 and 25 designate cooling inlet and outlet respectively, which may be present for a double-walled plasma chamber 20. In these embodiments, coolant flow is indicated by arrows 32 and 34.

In the embodiment depicted by FIG. 2, a plasma torch 21 is provided. The torch 21 may thermally decompose or vaporize the boron-containing precursor, carbon-containing precursor and sintering aid(s) within or near the plasma 29 as the stream is delivered through the inlet of the plasma chamber 20, thereby producing a gaseous stream. As is seen in FIG. 2, the precursors are, in certain embodiments, injected downstream of the location where the arc attaches to the annular anode 13 of the plasma generator or torch.

A plasma is a high temperature luminous gas which is at least partially (1 to 100%) ionized. A plasma is made up of gas atoms, gas ions, and electrons. A thermal plasma can be created by passing a gas through an electric arc. The electric arc will rapidly heat the gas by resistive and radiative heating to very high temperatures within microseconds of passing through the arc. The plasma is often luminous at temperatures above 9,000 K.

A plasma can be produced with any of a variety of gases. This can give excellent control over any chemical reactions taking place in the plasma as the gas may be inert, such as argon, helium, or neon, reductive, such as hydrogen, methane, ammonia, and carbon monoxide, or oxidative, such as oxygen, nitrogen, and carbon dioxide. Inert or reductive gas mixtures may be used to produce ultrafine boron carbide particles in accordance with the present invention. In FIG. 2, the plasma gas feed inlet is depicted at 31.

As the gaseous product stream exits the plasma 29 it proceeds towards the outlet of the plasma chamber 20. An additional reactant, as described earlier, can optionally be injected into the reaction chamber prior to the injection of the quench streams. A supply inlet for the additional reactant is shown in FIG. 2 at 33.

As is seen in FIG. 2, in certain embodiments of the present invention, the gaseous stream is contacted with a plurality of quench streams which enter the plasma chamber 20 in the direction of arrows 41 through a plurality of quench stream injection ports 40 located along the circumference of the plasma chamber 20. As previously indicated, the particular flow rate and injection angle of the quench streams is not limited so long as they result in impingement of the quench streams 41 with each other within the gaseous stream, in some cases at or near the center of the gaseous stream, to result in the rapid cooling of the gaseous stream to control the particle size of the ultrafine boron carbide particles. This may result in a quenching of the gaseous stream through dilution.

In certain methods of the present invention, contacting the gaseous stream with the quench streams may result in the formation and/or control of the particle size of the ultrafine particles, which are then passed into and through a converging member. As used herein, the term “converging member” refers to a device that restricts passage of a flow therethrough, thereby controlling the residence time of the flow in the plasma chamber due to pressure differential upstream and downstream of the converging member.

In certain embodiments, the converging member comprises a converging-diverging (De Laval) nozzle, such as that depicted in FIG. 2, which is positioned within the outlet of the plasma chamber 20. The converging or upstream section of the nozzle, i.e., the converging member, restricts gas passage and controls the residence time of the materials within the plasma chamber 20. It is believed that the contraction that occurs in the cross sectional size of the stream as it passes through the converging portion of nozzle 22 changes the motion of at least some of the flow from random directions, including rotational and vibrational motions, to a straight line motion parallel to the plasma chamber axis. In certain embodiments, the dimensions of the plasma chamber 20 and the material flow are selected to achieve sonic velocity within the restricted nozzle throat.

As the confined stream of flow enters the diverging or downstream portion of the nozzle 22, it is subjected to an ultra fast decrease in pressure as a result of a gradual increase in volume along the conical walls of the nozzle exit. By proper selection of nozzle dimensions, the plasma chamber 20 can be operated at atmospheric pressure, or slightly less than atmospheric pressure, or, in some cases, at a pressurized condition, to achieve the desired residence time, while the chamber 26 downstream of the nozzle 22 is maintained at a vacuum pressure by operation of a vacuum producing device, such as a vacuum pump 60. Following passage through nozzle 22, the ultrafine boron carbide particles may then enter a cool down chamber 26.

As is apparent from FIG. 2, in certain embodiments of the present invention, the ultrafine boron carbide particles may flow from cool down chamber 26 to a collection station 27 via a cooling section 45, which may comprise, for example, a jacketed cooling tube. In certain embodiments, the collection station 27 comprises a bag filter or other collection means. A downstream scrubber 28 may be used if desired to condense and collect material within the flow prior to the flow entering vacuum pump 60.

In certain embodiments, the residence times for materials within the plasma chamber 20 are on the order of milliseconds. When the boron-containing and carbon-containing precursors are provided in liquid form, they may be injected under pressure (such as from 1 to 300 psi) through a small orifice to achieve sufficient velocity to penetrate and mix with the plasma. In addition, in many cases the injected liquid stream is injected normal (90° angle) to the flow of the plasma gases. In some cases, positive or negative deviations from the 90° angle by as much as 30° may be desired.

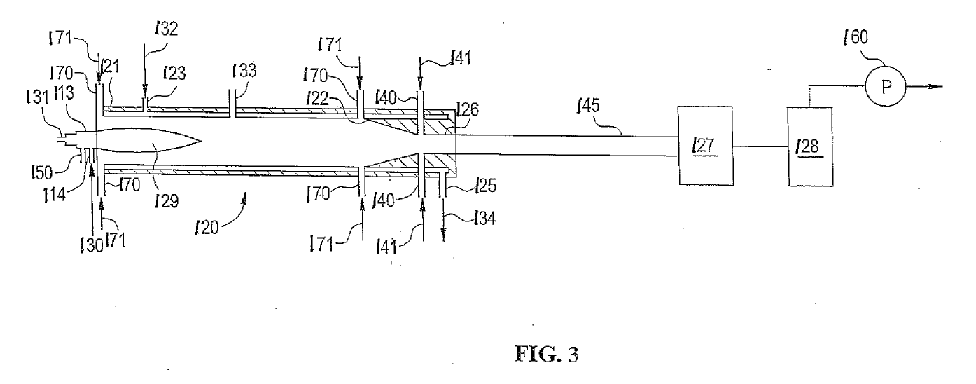

FIG. 3 is a partially schematic diagram of an apparatus for producing ultrafine particles in accordance with certain embodiments of the present invention. A plasma chamber 120 is provided that includes a precursor feed inlet 150. Also provided is at least one carrier gas feed inlet 114, through which a carrier gas flows in the direction of arrow 130 into the plasma chamber 120. As previously indicated, the carrier gas acts to suspend the precursor in the gas, thereby producing a gas-stream suspension of the precursor which flows towards plasma 129. Numerals 123 and 125 designate cooling inlet and outlet respectively, which may be present for a double-walled plasma chamber 120. In these embodiments, coolant flow is indicated by arrows 132 and 134.

In the embodiment depicted by FIG. 3, a plasma torch 121 is provided. Torch 121 thermally decomposes the incoming gas-stream suspension of precursors within the resulting plasma 129 as the stream is delivered through the inlet of the plasma chamber 120, thereby producing a gaseous product stream. As is seen in FIG. 3, the precursors are, in certain embodiments, injected downstream of the location where the arc attaches to the annular anode 113 of the plasma generator or torch.

In FIG. 3, the plasma gas feed inlet is depicted at 131. As the gaseous product stream exits the plasma 129 it proceeds towards the outlet of the plasma chamber 120. As is apparent, a reactant, as described earlier, can be injected into the reaction chamber prior to the injection of the quench streams. A supply inlet for the reactant is shown in FIG. 3 at 133.

As is seen in FIG. 3, in certain embodiments of the present invention, the gaseous product stream is contacted with a plurality of quench streams which enter the plasma chamber 120 in the direction of arrows 141 through a plurality of quench stream injection ports 140 located along the circumference of the plasma chamber 120. As previously indicated, the particular flow rate and injection angle of the quench streams is not limited so long as they result in impingement of the quench streams 141 with each other within the gaseous product stream, in some cases at or near the center of the gaseous product stream, to result in the rapid cooling of the gaseous product stream to produce ultrafine particles. This results in a quenching of the gaseous product stream through dilution to form ultrafine particles.

In certain embodiments of the present invention, such as is depicted in FIG. 3, one or more sheath streams are injected into the plasma chamber upstream of the converging member. As used herein, the term “sheath stream” refers to a stream of gas that is injected prior to the converging member and which is injected at flow rate(s) and injection angle(s) that result in a barrier separating the gaseous product stream from the plasma chamber walls, including the converging portion of the converging member. The material used in the sheath stream(s) is not limited, so long as the stream(s) act as a barrier between the gaseous product stream and the converging portion of the converging member, as illustrated by the prevention, to at least a significant degree, of material sticking to the interior surface of the plasma chamber walls, including the converging member. For example, materials suitable for use in the sheath stream(s) include, but are not limited to, those materials described earlier with respect to the quench streams. A supply inlet for the sheath stream is shown in FIG. 3 at 170 and the direction of flow is indicated by numeral 171.

By proper selection of the converging member dimensions, the plasma chamber 120 can be operated at atmospheric pressure, or slightly less than atmospheric pressure, or, in some cases, at a pressurized condition, to achieve the desired residence time, while the chamber 126 downstream of the converging member 122 is maintained at a vacuum pressure by operation of a vacuum producing device, such as a vacuum pump 60. Following production of the ultrafine particles, they may then enter a cool down chamber 26.

As is apparent from FIG. 3, in certain embodiments of the present invention, the ultrafine particles may flow from cool down chamber 126 to a collection station 127 via a cooling section 145, which may comprise, for example, a jacketed cooling tube. In certain embodiments, the collection station 127 comprises a bag filter or other collection means. A downstream scrubber 128 may be used if desired to condense and collect material within the flow prior to the flow entering vacuum pump 160.

The precursors may be injected under pressure (such as greater than 1 to 100 atmospheres) through a small orifice to achieve sufficient velocity to penetrate and mix with the plasma. In addition, in many cases the injected stream of precursors is injected normal (90° angle) to the flow of the plasma gases. In some cases, positive or negative deviations from the 90° angle by as much as 30° may be desired.

The high temperature of the plasma may rapidly decompose and/or vaporize the precursors. There can be a substantial difference in temperature gradients and gaseous flow patterns along the length of the plasma chamber. It is believed that, at the plasma arc inlet, flow is turbulent and there is a high temperature gradient from temperatures of about 20,000 K at the axis of the chamber to about 375 K at the chamber walls. At the nozzle throat, it is believed, the flow is laminar and there is a very low temperature gradient across its restricted open area.

The plasma chamber is often constructed of water cooled stainless steel, nickel, titanium, copper, aluminum, or other suitable materials. The plasma chamber can also be constructed of ceramic materials to withstand a vigorous chemical and thermal environment.

The plasma chamber walls may be internally heated by a combination of radiation, convection and conduction. In certain embodiments, cooling of the plasma chamber walls prevents unwanted melting and/or corrosion at their surfaces. The system used to control such cooling should maintain the walls at as high a temperature as can be permitted by the selected wall material, which often is inert to the materials within the plasma chamber at the expected wall temperatures. This is true also with regard to the nozzle walls, which may be subjected to heat by convection and conduction.

The length of the plasma chamber is often determined experimentally by first using an elongated tube within which the user can locate the target threshold temperature. The plasma chamber can then be designed long enough so that the materials have sufficient residence time at the high temperature to reach an equilibrium state and complete the formation of the desired end products.

The inside diameter of the plasma chamber may be determined by the fluid properties of the plasma and moving gaseous stream. It should be sufficiently great to permit necessary gaseous flow, but not so large that recirculating eddys or stagnant zones are formed along the walls of the chamber. Such detrimental flow patterns can cool the gases prematurely and precipitate unwanted products. In many cases, the inside diameter of the plasma chamber is more than 100% of the plasma diameter at the inlet end of the plasma chamber.

In certain embodiments, the converging section of the nozzle has a high aspect ratio change in diameter that maintains smooth transitions to a first steep angle (such as >)₄₅° and then to lesser angles (such as <45°) leading into the nozzle throat. The purpose of the nozzle throat is often to compress the gases and achieve sonic velocities in the flow. The velocities achieved in the nozzle throat and in the downstream diverging section of the nozzle are controlled by the pressure differential between the plasma chamber and the section downstream of the diverging section of the nozzle. Negative pressure can be applied downstream or positive pressure applied upstream for this purpose. A converging-diverging nozzle of the type suitable for use in the present invention is described in U.S. Pat. No. RE37,853 at col. 9, line 65 to col. 11, line 32, the cited portion of which being incorporated by reference herein.

The ultrafine boron carbide particles and sintering aids are consolidated in accordance with certain embodiments of the present invention. Consolidation may be by any of the known methods for ceramics including pressureless sintering, pressure sintering including hot pressing, microwave sintering and the field assisted sintering technique (FAST).

In the first step of pressureless sintering, a green body is formed from the ultrafine boron carbide particles and sintering aids. Standard green body formation techniques such as uniaxial pressing, isostatic pressing, tape casting, extruding and slip casting may be used. A binder in amounts typically from 0.5 to 5 weight percent may be added to the ultrafine boron carbide particles in order to aid in green body strength of the compressed powders. Examples of some suitable types of binders include poly(vinylalcohol), poly(ethylene glycol), poly(ethylene), stearic acid and the like.

The green body may be heated to about 400-600° C. under vacuum to remove the binders. In one embodiment, additional preheating of the green body may be conducted under vacuum. Such preheating at sub-atmospheric pressures may remove any unwanted boron oxide from the green body which could otherwise adversely affect the density or other properties of the sintered product. Preheating to temperatures of up to 1,500° C. may be used. After the preheating step, the green body may be sintered at a temperature of from 1,800-2,400° C. either in a vacuum or in the presence of an inert gas such as He, Ar, H₂ or the like. In order to further densify the body it may be subjected to hot isostatic pressing (HIP) at temperatures from 1,800-2,200° C.

The cooled sintered body is then recovered to provide a sintered boron carbide product which exhibits significantly reduced particle coarsening and high densities.

The following examples are intended to illustrate certain embodiments of the present invention, and are not intended to limit the scope of the invention.

### Example 1

Ultrafine boron carbide particles with various types and amounts of additional metals were produced as shown in Table 1 using a DC thermal plasma reactor system similar to that shown in FIG. 2. The Al, Ti, W and Mg sintering aid metals were provided from the following precursor materials: Al di(sec-butoxide) acetoacetate chelate (commercially available from Alfa Aesar, Ward Hill, Mass.) with a conversion ratio of 11.2 to 1 (i.e., 11.2 grams of Al di(sec-butoxide) acetoacetate chelate produces 1 gram of Al metal); titanium 2-ethylhexoxide (commercially available from Alfa Aesar, Ward Hill, Mass.) with a conversion ratio of 11.8 to 1; tungsten ethoxide (commercially available from Alfa Aesar, Ward Hill, Mass.) with a conversion ratio of 2.7 to 1; and magnesium methoxide (commercially available from Alfa Aesar, Ward Hill, Mass.) with a conversion ratio of 44.4 to 1. The boron source was trimethyl borate (commercially available from Rohm & Hass, North Andoverl, Mass.), and the carbon source was iso-octane (commercially available from Alfa Aesar, Ward Hill, Mass.), with a weight ratio of 29.11 to 1 of iso-octane to trimethyl borate to produce the desired 4:1 atomic ratio of B to C.

The main reactor system included a DC plasma torch (Model SG-100 Plasma Spray Gun commercially available from Praxair Technology, Inc., Danbury, Conn.) operated with 60 standard liters per minute of argon carrier gas and 24 kilowatts of power delivered to the torch. A precursor feed composition comprising boron-containing precursors, carbon-containing precursors, and the sintering aid materials in the amounts listed in Table 1 was prepared and fed to the reactor at a rate of 7 grams per minute through a gas assisted liquid nebulizer located about 0.5 inch down stream of the plasma torch outlet. At the nebulizer, 15 standard liters per minute of argon were delivered to assist in atomization of the liquid precursors. Following a 10 inch long reactor section, a plurality of quench stream injection ports were provided that included 6⅛ inch diameter nozzles located 60° apart radially. A 7 millimeter diameter converging-diverging nozzle was provided 4 inches downstream of the quench stream injection port. Quench argon gas was injected through the quench stream injection ports at a rate of 145 standard liters per minute. The produced boron carbide particles were purified using methanol to remove boron oxide and/or boric acid. The B.E.T. surface area of each boron carbide particulate sample and corresponding average particle size are listed in Table 1.

TABLE 1
Metal Additives to Ultrafine Boron Carbide Particles

| | | | | | | Average |
|---|---|---|---|---|---|---|
| | | | | | BETSA | Particle Size |
| Sample No. | Al | Ti | W | Mg | (m²/g) | (nm) |
| 1 | 0.1% | 0.1% | 0.1% | — | 38 | 63 |
| 2 | 0.5% | 0.1% | 0.1% | — | 46 | 52 |
| 3 | 1% | 1% | 0.1% | — | 46 | 52 |
| 4 | 1% | 0.1% | 0.5% | — | 54 | 44 |
| 5 | 0.1% | 0.5% | 0.5% | — | 36 | 66 |
| 6 | 0.5% | 0.5% | 0.5% | — | 36 | 66 |
| 7 | 1% | 0.5% | 1% | — | 53 | 45 |
| 8 | 0.1% | 1% | 1% | — | 32 | 74 |
| 9 | 0.5% | 1% | 1% | — | 47 | 51 |
| 10 | 0.1% | 0.5% | 0.1% | 0.5% | 49 | 49 |
| 11 | 1% | 0.5% | 0.1% | 0.5% | 58 | 41 |
| 12 | 0.5% | 1% | 0.1% | 0.5% | 47 | 51 |
| 13 | 0.5% | 0.1% | 0.5% | 0.5% | 45 | 53 |
| 14 | 0.1% | 1% | 0.1% | 0.5% | 50 | 48 |
| 15 | 1% | 1% | 0.5% | 0.5% | 59 | 40 |
| 16 | 0.1% | 0.1% | 1% | 0.5% | 47 | 51 |
| 17 | 1% | 0.1% | 1% | 0.5% | 49 | 49 |
| 18 | 0.5% | 0.5% | 1% | 0.5% | 54 | 44 |
| 19 | — | — | — | — | 33 | 72 |
| 20 | 0.5% | — | — | — | 36 | 66 |
| 21 | — | 0.5% | — | — | 27 | 88 |
| 22 | — | — | 0.5% | — | 31 | 77 |
| 23 | — | — | — | 0.5% | 26 | 92 |

### Example 2

Loose powders of the ultrafine boron carbide powders produced in accordance with Example 1 and listed in Table 1 were placed in a die and punch assembly (Model No. 3925, Carver, Inc., Wabash, Ind.) and pressed at 2960 atmospheres (300 MPa) to produce a powder compact with a green density greater than 60% of theoretical in the form of a cylindrical pellet 6.44 mm in diameter and 5 mm in height. The pellet is placed in a furnace that is then evacuated and filled with helium. The temperature is then ramped to 2,300° C. at 10° C./min under flowing helium and held at 2,300° C. for 1 hour. The furnace is then allowed to cool to less than 100° C. and the densified pellet is removed. Table 2 lists the green density, as-sintered density, and weight loss of each sample. The densities are measured in accordance with the ASTM C373(5.2) standard. It is noted that additional processing, such as hot isostatic pressing, may be used to further densify the as-sintered samples.

TABLE 2
Density Measurements

| Sample | Green Density | As-Sintered | Weight |
|---|---|---|---|
| No. | (%) | Density (%) | Loss (%) |
| 1 | 69.73 | 90.69 | 3.91 |
| 2 | 69.36 | 90.42 | 6.05 |
| 3 | 70.61 | 88.02 | 6.97 |
| 4 | 69.04 | 89.38 | 7.60 |
| 5 | 69.74 | 89.18 | 5.52 |
| 6 | 72.98 | 92.42 | 8.10 |
| 7 | 71.10 | 93.23 | 7.55 |
| 8 | 72.03 | 94.11 | 9.41 |
| 9 | 71.07 | 93.84 | 6.33 |
| 10 | 66.98 | 95.42 | 4.68 |
| 11 | 65.95 | 92.65 | 7.90 |
| 12 | 66.51 | 91.06 | 6.61 |
| 13 | 67.25 | 92.09 | 6.28 |
| 14 | 66.26 | 93.89 | 4.49 |
| 15 | 66.62 | 91.42 | 8.20 |
| 16 | 68.23 | 94.19 | 4.98 |
| 17 | 67.53 | 91.31 | 8.35 |
| 18 | 65.60 | 89.31 | 5.60 |
| 19 | 69.80 | 85.88 | 7.44 |
| 20 | 69.74 | 90.58 | 8.21 |
| 21 | 70.93 | 91.57 | 7.66 |
| 22 | 68.09 | 90.37 | 9.43 |
| 23 | 67.77 | 84.42 | 8.42 |

### Example 3

Sintering aid metals (0.1% Al and 1% W) were deposited on pre-formed boron carbide particles using the following procedure: add 1,000 g water in a flask/beaker; add 60 g pure sulfuric acid; add 100 g purified B₄C powder; mix the dispersion for 10 minutes; heat the solution at 50° C. for 60 minutes; filter the dispersion; rinse with DI water 500 ml; for every 100 g of purified B₄C powder add sufficient isopropanol (e.g., from 200 to 300 ml) to form a stirrable slurry; with stirring add 1.1 g aluminum di(sec-butoxide) acetoacetic ester chelate (Alfa 89349); with stirring add 2.6 g tungsten ethoxide solution (Alfa 45659); stir for 15 minutes; with stirring add dropwise 100 ml of water diluted in 200 ml of isopropanol; stir for 60 minutes then distill off the solvent; and dry in a vacuum oven at 100 degrees C. The resultant ultrafine particles comprise the pre-formed boron carbide particles with Al and W particles deposited thereon.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. Sintered ultrafine boron carbide particles comprising from 0.05 to 15 weight percent of a sintering aid comprising at least two metals selected from Ti, Al, W, Mg, Zr and Mo.

2. The sintered ultrafine boron carbide particles of claim 1, wherein the sintering aid comprises Ti.

3. The sintered ultrafine boron carbide particles of claim 2, wherein the sintering aid further comprises Al.

4. The sintered ultrafine boron carbide particles of claim 3, wherein the sintering aid further comprises W.

5. The sintered ultrafine boron carbide particles of claim 4, wherein the sintering aid further comprises Mg.

6. The sintered ultrafine boron carbide particles of claim 1, wherein the sintering aid comprises Al.

7. The sintered ultrafine boron carbide particles of claim 6, wherein the sintering aid further comprises at least one of W and Mg.

8. The sintered ultrafine boron carbide particles of claim 1, wherein the sintered boron carbide has an average grain size of less than 10 microns.

9. The sintered ultrafine boron carbide particles of claim 1, wherein the boron carbide is provided from ultrafine boron carbide particles having an average particle size of less than 100 nm.

10. Ultrafine boron carbide particles having an average particle size of less than 100 nm comprising from 0.05 to 15 weight percent of a sintering aid comprising at least two metals selected from Ti, Al, W, Mg, Zr and Mo.

11. The ultrafine boron carbide particles of claim 10, wherein the sintering aid comprises Ti, Al and W.

12. The ultrafine boron carbide particles of claim 11, wherein the sintering aid further comprises Mg.

13. The ultrafine boron carbide particles of claim 11, wherein the sintering aid is provided in the form of particles on the surfaces of the ultrafine boron carbide particles.

14. The ultrafine boron carbide particles of claim 11, wherein the sintering aid is provided inside each of the ultrafine boron carbide particles.

15. A method of making ultrafine boron carbide particles with sintering aids comprising forming at least two sintering aid metals selected from Ti, Al, W, Mg, Zr and Mo on or in ultrafine boron carbide particles.

16. The method of claim 15, wherein the ultrafine boron carbide particles are formed in a plasma chamber in the presence of the at least two sintering aid metals.

17. The method of claim 16, wherein at least one of the sintering aid metals is introduced into the plasma chamber in the form of an oxide of the sintering aid metal.

18. The method of claim 16, wherein at least one of the sintering aid metals is introduced into the plasma chamber in the form of a liquid precursor.

19. The method of claim 15, wherein the at least two sintering aid metals are deposited on the surfaces of pre-formed ultrafine boron carbide particles.

20. The method of claim 19, wherein at least one of the sintering aid metals is deposited on the surfaces of the ultrafine boron carbide particles in the form of an alkoxide of the sintering aid metal.
